(19) United States
(12) Patent Application Publication
(10) Pub. No.: US 2004/0154847 A1
(43) Pub. Date: Aug. 12, 2004

(54) Lightweight skirt assembly for air cushion vehicles

(76) Inventors: John E. Holland, Bailey, NC (US); Connie W. Holland, Bailey, NC (US)

Correspondence Address: WOMBLE CARLYLE SANDRIDGE & RICE, PLLC, P.O. BOX 7037, ATLANTA, GA, 30357-0037, US

(21) Appl. No.: 10/359,796

(22) Filed: Feb. 6, 2003

(51) Int. Cl. B60V 1/16

(52) U.S. Cl. 180/127

(57) ABSTRACT

A lightweight and durable skirt assembly for an air cushion vehicle having a rigid support structure. The skirt comprises at least one air chamber. The air chamber is formed from a substantially air impermeable, laminated sheet material. The laminated sheet material comprises a fabric made substantially from yarns that are formed from polymers of ultra-high molecular weight polyethylene. The fabric is laminated with a thermoplastic film.

### FIELD OF THE INVENTION

The present invention relates to the field of air cushion vehicles, and, more particularly to lightweight skirt assemblies for air cushion vehicles that are formed from a laminated sheet material that is a woven from yarns of ultra-high molecular weight polyethylene.

### BACKGROUND OF THE INVENTION

There are numerous types of air cushion transport vehicles and air flotation devices in commercial use today. These vehicles and devices generally operate on the principle of providing a downwardly directed airflow against a ground or water surface. This downwardly directed airflow results in a lifting force, creating a “hover” or “ground effect”. An example of a vehicle of this type is an air cushion vehicle known as the HOVERCRAFT™. While there are many types of these vehicles, they each operate under the same general principles. A system is generally employed to provide an air cushion that supports a load, i.e., the weight of the vehicle and its cargo, just above ground or water level. This system typically comprises multiple high volume, high pressure fans that effectively pressurize the air held beneath the vehicle with enough force to lift the vehicle just above the surface over which the vehicle is positioned. A separate motive source, comprising fans or turbines, then propels the vehicle over the surface of the ground or water.

Air cushion vehicles typically include a skirt around the base, or rigid support frame, of the vehicle to enclose and form the air cushion. One portion of the skirt forms an inflatable bladder, or bag member, that is stiffened when inflated, but yet is open at the bottom. The skirt may also include a plurality of contiguous skirt elements, known as “fingers”, depending downwardly from the bladder. The fingers provide auxiliary bladders and help direct the pressurized air beneath the frame of the vehicle.

Skirts have conventionally been made of only various types of rubber, both natural and synthetic, such as neoprene. A particular problem, however, with air cushion vehicle skirts is their susceptibility to damage and rapid deterioration due to constant impingement by water or foreign objects. Further, when used in a salt water environment, rapid deterioration of the skirt material necessitates frequent replacement of the skirt after only a few operating hours, and at substantial costs.

Numerous attempts have been made to construct more durable, longer-lasting skirts, but have proven unsatisfactory for one reason or another. In one skirt construction, apertured flexible sheets formed from a reinforcing fabric with an elastomeric protective material has been tried. In another, a molded seamless skirt has been formed from a high strength woven aramid known as KEVLAR®, but based upon experimentation, KEVLAR® cannot withstand salt-water attack and ultraviolet light. Steel wire has been woven into some conventional fabric constructions, but has not resulted in any appreciable reduction in wear or longevity of the skirt.

At present, the average skirt installed on air cushion vehicles operated by the United States Navy must be replaced between at least about every 100 to 200 operating hours. Additionally, the fabric conventionally used in such air cushion vehicles weighs approximately 80 ounces per square yard. Lighter weight materials have not heretofore been considered for skirt constructions for this rugged application. While a heavy fabric construction such as this is currently believed to be necessary for durability and longer service life, the substantial weight of the skirt is significant, resulting in high fuel, maintenance, and replacement costs. Further, and no less important, frequent replacement and maintenance significantly affects the operational readiness of these military vehicles and reduces the loads that these vehicles can carry.

### SUMMARY OF THE INVENTION

The present invention is directed to lightweight, durable skirt assemblies, or portions thereof, for air cushion vehicles that will reduce overall operational fuel costs, require less frequent replacement, and increase the payloads that the vehicles can carry. The skirt assemblies are constructed from a unique laminated sheet material comprising a woven fabric of ultra-high molecular weight polyethylene yarns, having a thermoplastic film laminated to at least one surface thereof. The invention is directed to the use of this sheet in any configuration of skirts and/or fingers, and not to any particular type, geometry, or configuration for skirt assemblies.

The laminated sheet material is flexible, substantially air impermeable, and lightweight, and can be cut and formed into the bladder, fingers, aprons, or other skirt portions for installation on air cushion vehicles. An example of a suitable fabric which would appear to be appropriate is disclosed in U.S. Pat. No. 6,280,546 to Holland et al. This patent describes a cut and puncture resistant laminated fabric comprising a thermoplastic film and a fabric woven from ultra-high molecular weight polyethylene. The thermoplastic film is laminated under heat and pressure to the woven fabric. This fabric is described as being useful in the manufacture of such products as cut-resistant gloves and aprons, cargo container covers, bulk mail bags, and the like.

Weight and durability are factors that must be properly balanced for air cushioned vehicle operation. Heretofore, greater durability has meant heavier constructions and, therefore, greater fuel costs, but with reduced load-carrying capabilities. Even with such heavier materials, skirts must still be replaced more frequently that is economically, or operationally, desirable.

While not previously appreciated, it has now been found that woven fabric constructions of ultra-high molecular weight polyethylene yarns, when laminated with a thermoplastic sheet under pressure as described in Holland et al., will yield a highly durable laminated sheet that will better withstand the wear and tear inherent in marine and ground applications for air cushion vehicles. Further, the laminated sheet does not suffer delamination to the extent that functionality is impaired. As used herein, “ultra-high molecular weight” means molecular weights greater than about 3 million.

In a preferred embodiment, ultra-high molecular weight yarns of between about 650 and 1200 denier are used to form an un-laminated fabric weighing between about 5.5 and 10.7 ounces per square yard. When laminated with between about 7 mils and 40 mils of a thermoplastic film on either side, the final laminated fabric sheet weighs between about 19 and 60 ounces per square yard.

These and other aspects of the present invention will become apparent to those skilled in the art after a reading of the following description of the preferred embodiments when considered in conjunction with the drawings. It should be understood that both the foregoing general description and the following detailed description are exemplary and explanatory only and are not restrictive of the invention as claimed.

### BRIEF DESCRIPTION OF THE DRAWINGS

FIG. 1 is a top perspective view of one embodiment of the skirt assembly of the present invention;

FIG. 2 is a side view of the embodiment of FIG. 1;

FIG. 3 is a sectional view of the embodiment of FIG. 1 taken along Line 3-3;

FIG. 4 is a perspective view of an alternative embodiment of the present invention;

FIG. 5 is a top view of the alternative embodiment of FIG. 4;

FIG. 6 is a perspective view of a second alternative embodiment of the present invention; and

FIG. 7 is a side view of the alternative embodiment of FIG. 6.

### DETAILED DESCRIPTION OF THE PREFERRED EMBODIMENTS

Flexible skirt assemblies for air cushion vehicles may be constructed in numerous ways. In all cases, the skirt assemblies, or portions thereof, enclose, or create, an air cushion volume beneath the vehicle during operation.

It has been found that a laminated fabric constructed of high performance yarns formed from polymers of ultra-high molecular weight polyethylene similar to fabrics taught in the Holland et al. patent (U.S. Pat. No. 6,280,546) is quite suitable for use in such skirt assemblies. The fabric is woven from yarns of high-strength, ultra-high molecular weight polyethylene, commonly known as SPECTRA®, available from Allied Signal. The fabric comprises SPECTRA® yarns woven with between about 17 and 35 ends per inch in both the warp and fill directions. The yarns are each between about 650 and 1200 denier. The result is a laminated woven fabric weighing between about 19 and 28 ounces per square yard. This contrasts with neoprene sheet material that is currently used to form the skirt assemblies, and weighing about 80 ounces per square yard, or about 3 to 4 times heavier.

The following table provides fabric constructions that have been found suitable for use in forming the skirt assemblies of the present invention. As those skilled in the art will appreciate, the fabric constructions described here are exemplary only and not intended to limit the invention thereto. Each of these unlaminated fabrics is available from Hexcel Schwebel of Anderson, S.C.:

| | | | | | Yarn |
|---|---|---|---|---|---|
| | | Weight | Thickness | Counts | Denier |
| Style | Weave | (Oz/Yd) | (Inches) | (Ends/Inch) | (Warp/Fill) |
| 902 | Plain | 5.5 | 0.018 | 17 × 17 | 1200/1200 |
| 904 | Plain | 6.3 | 0.017 | 35 × 35 | 650/650 |
| 952 | Plain | 6.0 | 0.017 | 34 × 34 | 650/650 |

As shown in the table, a plain weave fabric having 17 ends per inch of 1200 denier SPECTRA® in both the warp and fill directions weighs only about 5.5 ounces per square yard, but has a breaking strength of greater than 800 pounds force per inch in both directions. The heaviest fabric construction shown in the table and used in constructing the skirt assemblies of the present invention is a plain weave comprising 35 ends per inch, warp and fill, of 950 denier yarns. This heavier construction weighs only about 6.3 ounces per square yard. In addition to the plain weave constructions shown in the table, a 4×4 basket weave comprising 34 ends per inch of 1200 denier yarns, warp and fill, and weighing 10.7 ounces per square yard, has also been found suitable.

As described more fully in Holland et al., any suitable polyethylene or ethylene vinyl acetate (EVA) film can be used to laminate the high performance sheet material. More specifically, while a thickness of up to 40 mils is possible, it has been found that a thermoplastic film laminate of between about 7 and 15 mils thickness on each side of the fabric provides the most suitable flexible sheet construction. Polyethylene and ethylene vinyl acetate each weigh about one ounce per mil of thickness per square yard. Thus, a 7 mil laminate on both sides of the fabric sheet adds approximately 14 ounces to the total weight per square yard. The final laminated sheet material then weighs only between about 19 ounces per square yard and 28 ounces per square yard.

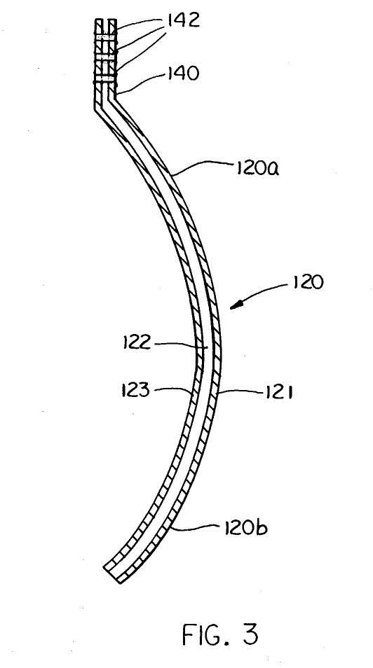

Referring to FIG. 3, a sectional view of the laminated flexible sheet 120 is shown in detail. The high performance fabric 122 is shown laminated on both sides with thermoplastic film 121, 123. Once the laminated sheet material has been formed according to Holland et al., the sheet material 120 can be conventionally cut and shaped to form any of the exemplary skirt assemblies illustrated herein.

In one conventional construction, the skirt assembly includes a pressurized member, or bladder, and may include one or more covers to protect the bladder. In another conventional construction, contiguous “fingers” communicate with the bladder around its entire periphery. As those skilled in the art will appreciate, the configuration, geometry, and method of attachment of the various types of skirt assemblies are dependent upon operating air pressures, air inlet configuration for the particular vehicle, variable output of the lift fans, weight and size of the vehicle, etc. The embodiments described below are exemplary of skirt assembly constructions that may be formed with the cut and abrasion resistant fabric described herein, but are not limited thereto.

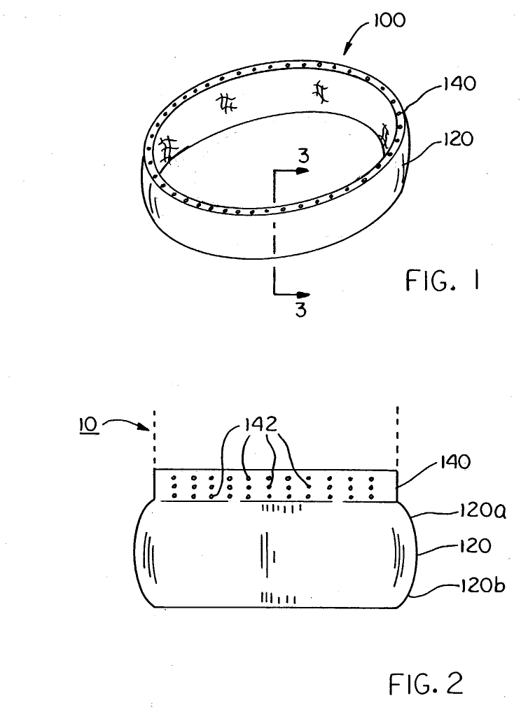

As shown in FIG. 1, a first embodiment of the present invention is directed to a flexible skirt assembly formed from cut and abrasion resistant, laminated fabric. A detailed construction of this type of flexible skirt geometry is described in U.S. Pat. No. 4,339,017 to Payne. Shown generally as 100 in FIG. 1 and in greater detail in FIGS. 2 and 3, the flexible skirt assembly comprises a continuous annular upper wall 120 having a curved wall portion 120a, a curved wall portion 120b, and a contiguous upper peripheral attachment portion 140. As used herein, the term “continuous wall” means that there are no openings or gaps in the wall surface, whether the annular wall is formed from a single piece of fabric or a plurality of pieces that are interconnected. The continuous annular wall 120 and attachment portion 140 are formed from the lightweight flexible laminated fabric described hereinabove.

Referring again to FIGS. 1 through 3, for example, there is shown the skirt assembly 100 of relatively simple construction in which the entire assembly comprises a singular laminated skirt 120 and attachment portion 140 that extends completely around and is fastened to the periphery of the frame 10 of an air cushion vehicle. Those skilled in the art will appreciate the well known techniques for cutting and shaping a fabric to extend around such a frame 10 such that the arcuate geometry shown in FIGS. 1 through 3 is obtained. It will also be understood that such a construction will require that one or more seams be created to enclose the skirt 100 around the vehicle. As best shown in FIGS. 2 and 3, the upper attachment portion 140 is integrally formed with the skirt 120. Grommets 142, or other suitable attachment points, are formed therethrough the upper attachment portion 140 so that the skirt 120 may be installed and removed, as required.

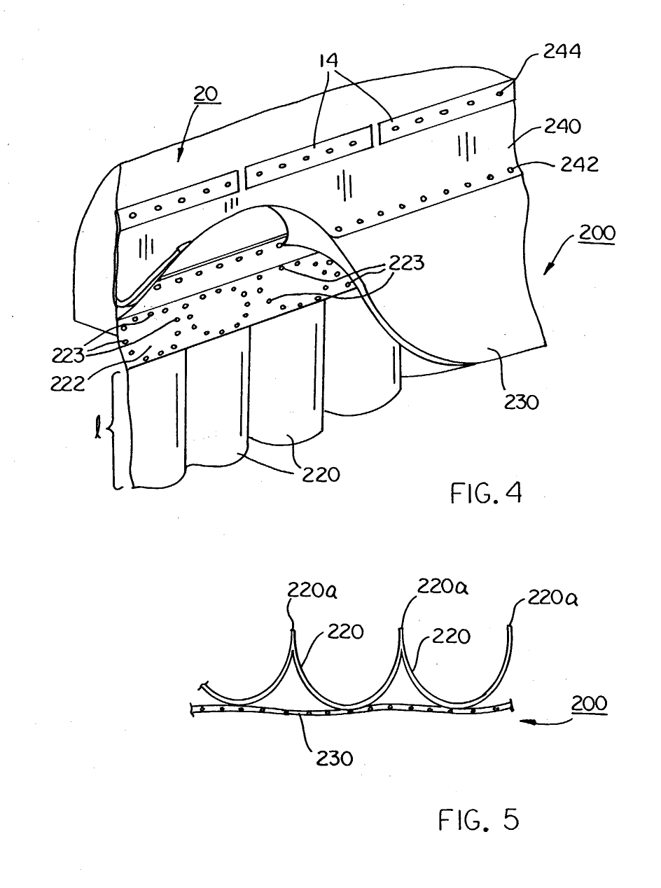

Turning now to FIGS. 4 and 5, a second exemplary construction of a skirt assembly 200 for an air cushion vehicle is shown. A detailed construction of this type of flexible skirt assembly is described in U.S. Pat. No. 3,211,246 to Lewis. Shown generally as 200, the assembly includes a plurality of fingers 220 formed from the laminated flexible sheet material described above. The series of fingers 220, interconnected at points 220a, extend around the entire periphery of the frame 20 of the air cushion vehicle. As shown in FIG. 5, the fingers 220 are generally arcuate or elliptically shaped in geometry and extend from the frame 20 downwardly a desired length, l. The length l of the fingers 220 is dependent upon the particular air cushioned vehicle design.

In the embodiment shown in FIGS. 4 and 5, the fingers 220 perform the same “bladder” function during operation that the skirt assembly 100 does in the embodiment shown in FIGS. 1 through 3. Attached along the upper portions of the series of fingers 220 is an attachment portion 222. Attachment portion 222 provides a measure of rigidity to upper portions of the series of interconnencted fingers and also provides the attachment surface for affixing the skirt assembly 200 to the frame 20 of the air cushion vehicle. Grommets 223, or other suitable attachment points, are formed therethrough the attachment portion 222 so that the skirt assembly 200 may be installed and removed, as required. Skirt assembly 200 may further include an upper attachment, or support, portion 240, having attachment points 242 and 244. While not part of the skirt assembly 200, semi-rigid or rigid holders 14 may be required to securely hold the skirt assembly 200 on the frame 20 of the vehicle.

As is conventional in some air cushioned vehicle skirt assemblies, an apron 230, is optionally attached to the frame 20 of the vehicle and drapes downward over the fingers 220. The apron 230 is constructed of the same laminated sheet material as the fingers 220, and also extends around the entire periphery of the vehicle.

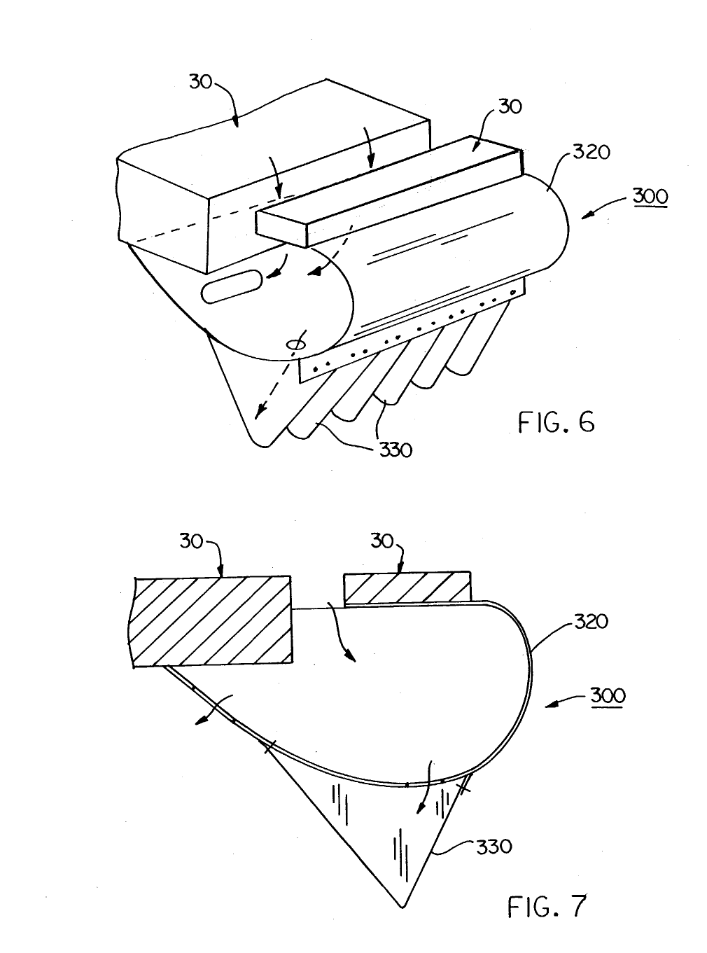

Referring now to FIGS. 6 and 7, a third type of skirt assembly structure 300 known in the art is shown. A detailed construction of this type of flexible skirt assembly is described in U.S. Pat. No. 3,618,695 to Wheeler. The skirt assembly comprises a bladder 320 and a series of contiguous fingers 330 in fluid communication with the bladder 320. In this type of configuration, the bladder 320 extends completely around the periphery of the frame, with a substantial portion of the bladder attached to the underside of the frame 30. Again, the fingers 330 and bladder 320 are formed of the same flexible sheet material as described hereinabove.

Although the present invention has been described with exemplary constructions, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. A lightweight and durable skirt assembly for an air cushion vehicle having a rigid support structure, the skirt comprising:
(a) at least one air chamber; and
(b) the air chamber is formed from a substantially air impermeable, laminated sheet material, the laminated sheet material comprising a fabric made substantially from yarns that are formed from polymers of ultra-high molecular weight polyethylene, the fabric being laminated with a thermoplastic film.

2. The lightweight durable skirt assembly of claim 1 wherein the laminated sheet material weighs between about 19 ounces per square yard and 28 ounces per square yard.

3. The lightweight durable skirt assembly of claim 1 wherein the air chamber is a continuous wall so formed and shaped to attach around the periphery of the rigid support structure so that the skirt assembly will inflate when the air cushion vehicle is operated.

4. The lightweight durable skirt assembly of claim 3 where in the continuous wall has an inwardly curved upper portion and an inwardly curved lower portion, and an upper edge for attachment to the rigid support structure.

5. The lightweight durable skirt assembly of claim 1 wherein the air chamber comprises a plurality of interconnected fingers.

6. The lightweight durable skirt assembly of claim 1 wherein the air chamber comprises:
(a) a bladder; and
(b) a plurality of fingers connected to and in fluid communication with the bladder.

7. The lightweight durable skirt assembly of claim 1 wherein the fabric is woven and prior to lamination weighs between about 5 and 11 ounces per square yard, comprises between about 17 ends and 35 ends in both the warp and fill directions, and wherein each of the warp and fill ends are between about 650 and 1200 denier.

8. The lightweight durable skirt assembly of claim 1 wherein the thermoplastic film is selected from the group consisting of polyethylene and ethylene vinyl acetate.

9. The lightweight durable skirt assembly of claim 1 wherein the thermoplastic film is laminated to both sides of the fabric to a thickness of about 7 mils, the film weighing about 1 ounce per square yard per mil of thickness.

10. The lightweight durable skirt assembly of claim 1 wherein:
(a) the fabric is woven and includes between about 17 and 35 ends of the yarn in both the warp and fill directions, wherein each yarn end is between 650 and 1200 denier; and
(b) the film material is selected from the group consisting of polyethylene and ethylene vinyl acetate, the film being laminated to both sides of the fabric to a thickness of about 7 mils.
